(19) United States
(12) Patent Application Publication
(10) Pub. No.: US 2018/0051401 A1
(43) Pub. Date: Feb. 22, 2018

(54) GARMENT WITH ELASTIC INSERTS PRODUCED USING CIRCULAR MACHINES

(71) Applicant: PRO EIGHT S.r.l., Brescia (IT)

(72) Inventor: Fabio GIORGINI, Monticelli Brusati (Brescia) (IT)

(21) Appl. No.: 15/560,292

(22) PCT Filed: Mar. 22, 2016
(86) PCT No.: PCT/IT2016/000070

§ 371 Date: Sep. 21, 2017

(30) Foreign Application Priority Data
Mar. 27, 2015 (IT) RM2015A000129

(51) Int. Cl. D04B 1/24; A41B 11/00; A41B 11/02; A41D 13/06; A41D 1/08; A41D 13/05; A41B 1/08; A61H 1/00; D04B 1/18

(52) U.S. Cl. CPC D04B 1/24; A61H 2209/00; A41B 11/02; A41D 13/065; A41D 1/08; A41D 13/0543; A41B 1/08; A61H 1/006; D04B 1/18; A41B 2500/10; A41B 2400/322; A41D 2400/322; A41D 2500/10; A41D 2600/10; A41D 2600/20; A61H 2201/164; A61H 2201/165; A61H 2201/1635; A61H 2201/1619; A61H 2205/102; A61H 2205/12; A41B 11/003

(57) ABSTRACT

The present invention relates to a garment with elastic inserts produced on circular machines of the type comprising elasticised sectors (3) and elasticised zones obtained by working in a further elastomeric yarn—in addition to the ground yarn and the reinforcing yarn normally used—and actually knitting the yarns so as to create machined portions, both horizontally and obliquely, which result in well-defined and demarcated zones which provide greater compression than the knitted stitches on the same row, thereby providing—within the elasticised sectors (3)—a greater compression value than outside the sector on the same row of knitted stitches. The elasticised sectors (3) are designed portions which create ornamental figures or banding with specific compression which can provide support, contribute to the stimulation of blood circulation, reduce fatigue, and render movement safer and more supported, when properly positioned and sized.

### TECHNICAL FIELD

The present invention relates to a garment with elastic inserts produced using circular machines which are particularly suitable to create differentiated zones with specific, localised compression which provides, for example, support, stimulation of blood circulation, massage to stimulate musculature, shock-absorbing protection, etc.

### BACKGROUND ART

At present, for products produced using circular machines, such as socks and underwear, the conformation of the knitting is a direct consequence of the spiraloid construction of the article. The construction is comparable with the thread of a screw as due to the formation of the knitting, which is carried out around a circumference and is repeated at each turn of the cylinder, superimposing a succession of rows of knitting, always in the same direction. The spirality of the knitted fabric results in the fact that the yarns used to create an ornamental pattern or other layout also follow the spiral machining setting, starting the knitting action with a row of knitting at a given point and at a specified number of turns of the cylinder and terminating one or more turns later, and—therefore—always with the design developing in a horizontal direction. In particular, when one wishes to create a design which runs downwards, in an oblique fashion, along the semi-finished item be that a sock or a top, it is necessary to insert a further ground yarn and then, immediately after a certain number of points, cut such yarn using an appropriate device in order to achieve the desired design width and endeavouring to prevent slip-off, so as to proceed consistently therewith in the subsequent rows.

The system just illustrated for circular machines is practicable with non-elasticised yarns or with yarns with a low degree of elastication, therefore such types of machining strictly preclude elastomeric yarns or compound yarns, including therein those with only a percentage of elastomer. Unfortunately, such yarns are the only ones which allow a significant compression effect to be achieved, due to the intrinsic elasticity thereof, in addition to that provided by the knitting itself, and—for this reason—such yarns are widely used in both the sports field and the medical field.

The difficulty in the use of elastomeric yarns is due to the fact that, once knitted, the yarn—by its very nature—tends to come out of the knitting, since when cut, the yarn shrinks backwards, in the insertion direction, losing effectiveness and, consequently, fraying occurs, which is aesthetically displeasing and makes the presence of the elastic yarn less effective since the yarn loses grip substantially.

As is known, at present, elastic yarn is used as the ground yarn or as a textured yarn in order to create elasticity and compression and when there is a need to lend the article greater compression, one simply tightens, i.e. tensions, the yarn further. Such method, however, requires the presence of elastic yarn throughout the knitted fabric.

In particular, in socks, but also in garments such as tops or leggings, an elastic “banding” effect is achieved by means of towelling processing, which means that such insert is voluminous and can be uncomfortable, and furthermore still does not offer adequate compression due to the thickness thereof, which prevents proper tension, thereby limiting the compression effect. Moreover, in some types of socks a “banding” effect is produced, but solely within a designed area which features different machining in solely visual terms, since it does not correspond to a different structure in the fabric with a different compression and/or grip capacity. Such area is solely a psychological aid, but not a real, effective one.

In addition to everything illustrated so far, there is a demand expressed by the market for—for example—a sock which features a knitted fabric with a slim, flat knit which, at the same time, is capable of providing compression in well defined zones and protection in particular zones.

As it is known, nowadays, there is a lot of interest among users in clothes and accessories which are comfortable, practical, functional, aesthetically pleasing, and flexible in terms of the use thereof.

Indeed, it is a known fact, for example, that sportsmen and women are particularly demanding and careful about their choices when it comes to the clothing and accessories they use for their sporting activities, which means they refuse to accept compromises such as garments which do not meet up to their expectations and needs, and which even sometimes wrongfully heighten expectations.

### Disclosure of Invention

The aim of the present invention is essentially to solve the problems of the commonly known technique, overcoming the drawbacks described above by means of a garment with elastic inserts produced using circular machines which features a design with an elastomer yarn in an oblique—and likewise—horizontal direction and, in any case, in limited, predefined zones.

A second aim of the present invention is to produce a garment with elastic inserts produced using circular machines, the said inserts being able to adapt perfectly to the body's morphology without an uncomfortable thickness, in addition to forming precise stretches of greater compression with respect to the knitting present on the same row. A further aim of the present invention is to produce a garment with elastic inserts produced using circular machines able to allow the user to obtain stimulation of the blood circulation, a massaging effect, support, and remarkable comfort when worn.

A further aim of the present invention is to produce a garment with elastic inserts produced using circular machines, the said inserts featuring suitable elastic bands or elastic zones with different specific degrees of elasticity for containment.

A further aim of the present invention is to produce a garment with elastic inserts produced using circular machines which can be donned and removed quickly and easily.

A still further and not final aim of the present invention is to produce a garment with elastic inserts produced using circular machines which is easy to make and works well.

These aims and others besides, which will better emerge over the course of the present description, are essentially achieved by means of a garment with elastic inserts produced using circular machines, as outlined in the claims below.

Further characteristics and advantages will better emerge in the detailed description of a garment with elastic inserts produced using circular machines, according to the present invention, provided in the form of a non-limiting example, with reference to the accompanying drawings, in which:

### BRIEF DESCRIPTION OF DRAWINGS

FIG. 1 shows a diagram of the production of the knitting on a circular machine.

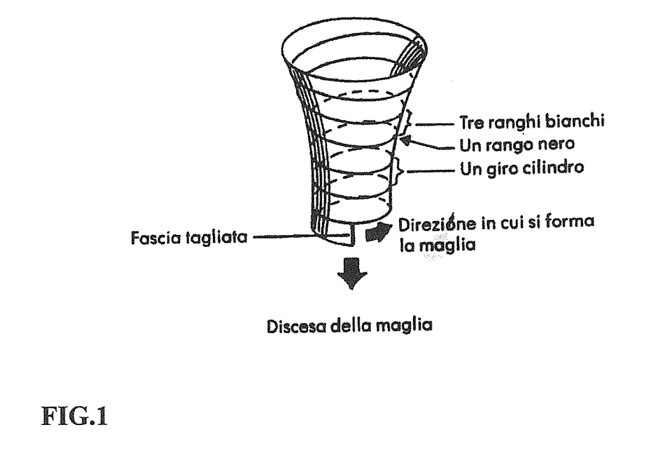

FIGS. 2A, 2B, 2C, and 2D, show, schematically, a garment with elastic inserts produced using circular machines according to the present invention;

FIGS. 3A, 3B, 3C, and 3D, show, schematically, a variant of the garment in FIG. 2;

FIGS. 4A and 4B, show, schematically, respectively from a front view and a rear view, a different garment with elastic inserts according to present invention;

FIGS. 5A and 5B, show, schematically, respectively from a front view and a rear view, a further garment with elastic inserts.

### BEST MODE FOR CARRYING OUT THE INVENTION

With reference to the aforesaid figures, 1 is used to denote, as a whole, a garment with elastic inserts produced using circular machines according to the present invention.

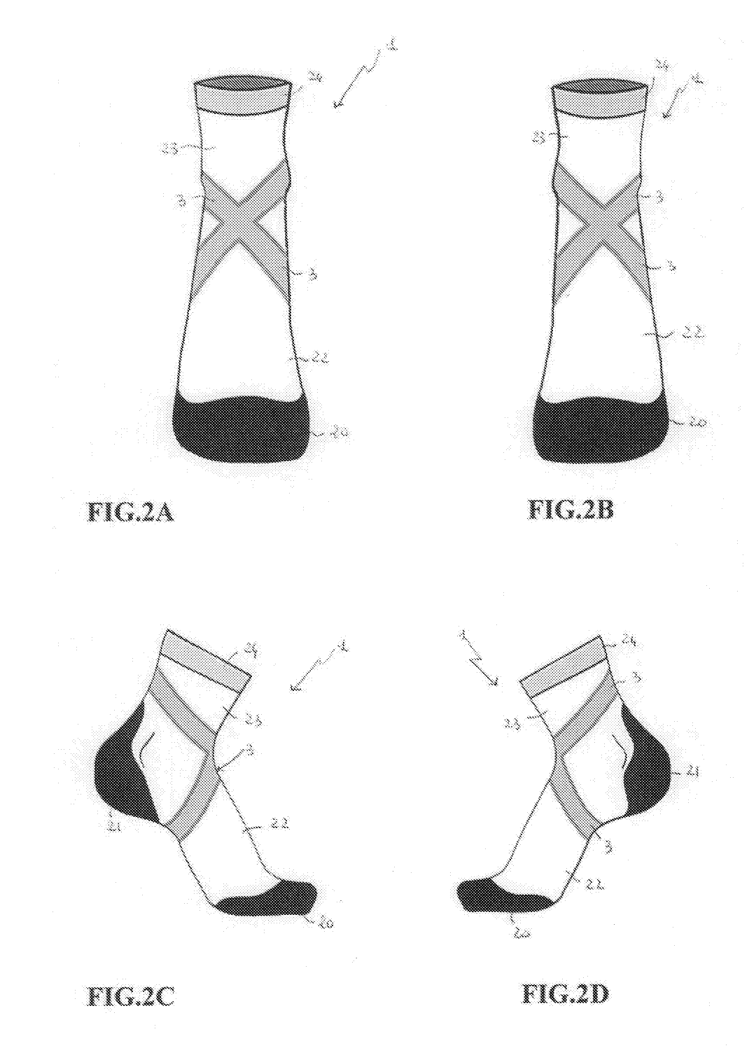

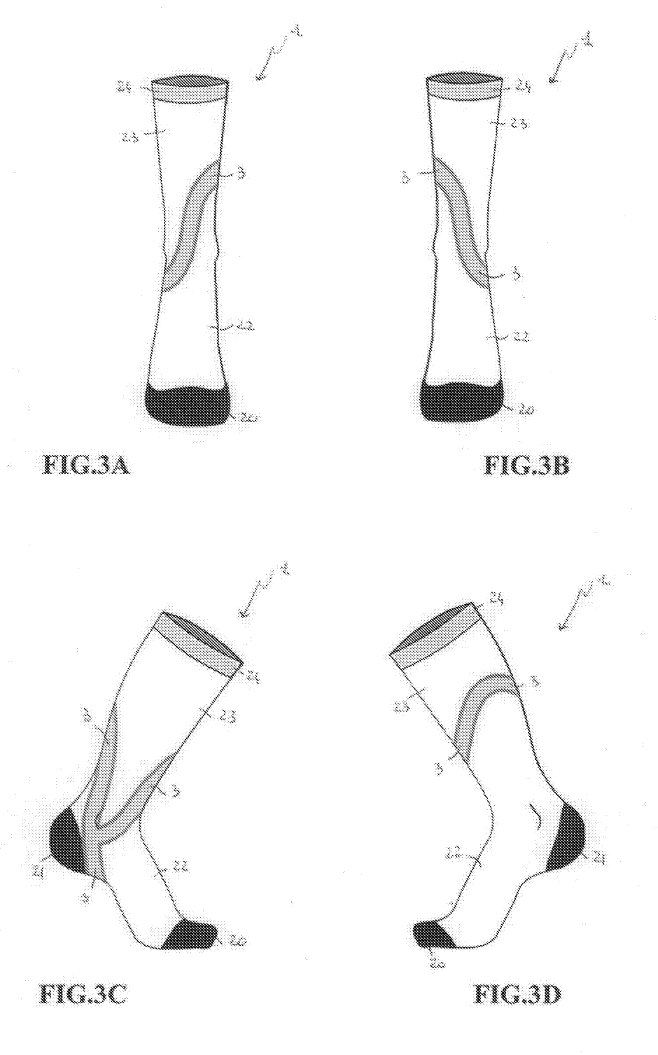

As shown in FIGS. 2A, 2B, 2C, and 2D and in FIGS. 3A, 3B, 3C, and 3D, the garment 1 in question is a sock which features and is configured like a conventional sock with a toe 20, a conventional heel 21, a part 22 which wraps around the foot, a part 23 which wraps around the ankle and the leg, and an elasticised edge 24 envisaged to adhere to the user's leg so as to ensure the garment does not slide down the aforesaid leg.

The sock produced according to the present invention features elasticised sectors 3 obtained by working in a further elastomeric yarn—in addition to the ground yarn and the reinforcing yarn normally used—and actually knitting the yarns. This way, machining portions are created in both a horizontal and an oblique direction, giving origin to well defined and demarcated zones, as shown, for example, in FIG. 2B, which provide greater compression with respect to the knitting on the same row.

More specifically, within the elasticised sectors 3, there is a higher compression rate with respect to the exterior of the sector on the same row of knitting.

Such elasticised sectors 3 are designed and create ornamental figures or banding with specific compression which can contribute to the stimulation of blood circulation when properly positioned and sized, such as, for example, when they are placed around the ankle bone and straddling the neck of the foot, as shown in FIGS. 2A and 2C or stretching up to the calf, as in FIGS. 3A and 3C. In this case, the elasticised sector has a conformation reminiscent of a Y, which is used to stabilise the ankle bone joint, contributing to the stimulation of the calf, and when the muscle is under tension, such sector provides support which reduces the sensation of fatigue, in addition to reducing strain.

In accordance with the present invention, a further elasticised sector 3 is located over the neck of the foot (with an extension towards the ankle on one side and towards the forefoot on the other), wrapping it, as shown in FIGS. 2B and 2D. The elasticised sector just illustrated is designed to contain the joint of the neck of the foot, thereby controlling the type of movement possible.

As shown in FIGS. 2C and 2D, a still further sector 3 is placed under the foot, at the arch thereof, and running up to the inner ankle with an essentially “bean-like” shape, which is designed to support the arch of the foot, thereby providing a feeling of comfort and containment of the foot, in order to stimulate blood circulation while also providing support. Furthermore, the sectors 3 provide external protection for parts of the foot and/or leg against blows caused by falling or by rubbing, thereby providing a cushioning effect. Such protection is particularly recommended in sports socks, to protect the ankle bones or joints or muscles—for example, of a skier—but also in work socks for those who are always on the move.

In particular, the elasticised sectors 3 produce an effective massage effect which offers the user a feeling of comfort since movement is made safer and more supported.

In addition to everything illustrated so far, the presence of the elasticised sectors 3 in the sock allows the creation and insertion of appropriate elastic bands or stretches with different specific degrees of elasticity for containment, which allow lines of tension to be created and supported which perform a lymphatic massage which stimulates the musculature, therefore benefits can be obtained with regard to muscle or tendon fatigue.

As mentioned above, the elasticised sectors 3 are obtained by inserting an elasticised yarn during the formation of the knitting, or by inserting the yarn when one intends to start creating the elasticised sector and working the elastic yarn in with the ground yarn, starting the knitting of the elastic yarn by forming a row of knitting at a given point of one round and knitting a given number of stitches, depending on the desired width; the elastic yarn is then cut and secured by knitting such yarn in with other binding yarns, which are used separately from the ground yarn to secure the stitches and are present at both the beginning of the machining with the elastomeric yarn and the end of the line in the sector. On the next round, at the predetermined point, the elastic yarn is taken up again and worked for the number of stitches established in the design and can be equal to the number of stitches in the previous row, or higher or lower in number, depending on the shape of the sector one wishes to produce. The machining then continues as described for as many rounds as necessary in order to reach the height and the shape of the sector to be produced.

In more detail, during machining with a circular motion, the elastic yarn is machined together with the binding yarns for a given number of stitches, and when the portion is complete, the elastic yarn is once again joined with another yarn, which is used to bind and secure such the former yarn, i.e. the yarn is knitted in for a given number of stitches which varies depending on the desired design to be produced. The elastic yarn is then cut and brought back to the starting point by the yarn guide, ready for the next round of knitting. The operation for the knitting and binding of the elastic yarn with another yarn used in the machining allows a contour/profile to be created which “frames” the elasticised sector 3. In particular, the binding yarn creating the contour/profile may be highlighted if one produces a decorative design inside the sector or is less apparent if the sector is produced using a yarn with the same colour.

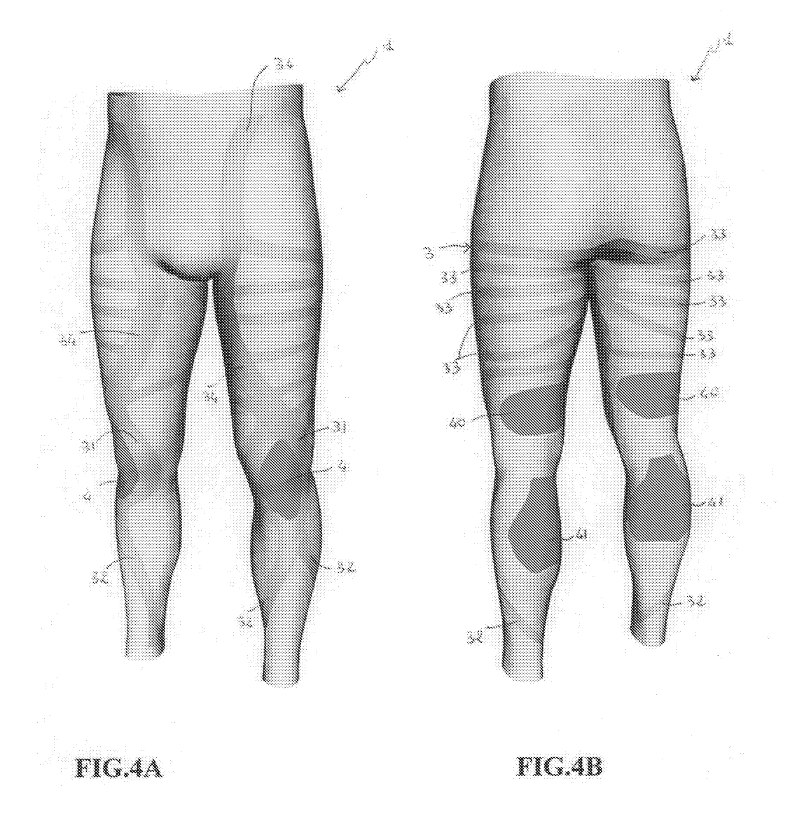

In accordance with the present invention, a further garment consists of trousers or leggings, as shown in FIGS. 4A and 4B.

The trousers 1 have elastic sectors located in different points and with particular configurations.

As shown in FIG. 4A, a first sector 31 is positioned so as to surround the kneecap to give a sense of grip, and therefore stability at the user's knee, alleviating strain on the ligaments, containing the muscles, and providing a sense of protection. From such sector, bands 32 branch off and, running around the leg, support the calf, following the same principle and conformation as described earlier for socks.

Furthermore, and also in the knee zone, there is a zone 4 endowed with less elastic compression, which is designed to help support the kneecap and distribute the compression over the kneecap tendon.

The trousers feature a second elasticised zone 40, located at the biceps femoris muscle of the thigh, which is endowed with a particular weave designed to support and massage such muscle.

A further zone 41 features less elastic compression and exerts action on the twin muscle of the calf, thereby providing support and performing a massage action.

In addition to everything illustrated so far, the trousers feature a rear sector 33 composed of a multitude of appropriately distributed bands, as shown in FIG. 4B, whose task is to support the gluteus, performing a lymphatic massage action.

Such arrangement of bands—by stimulating microcirculation—promotes not only circulation of the lymphatic system, but also faster metabolic exchange, thereby reducing fatigue and the production of lactic acid and improving both sporting performance and endurance.

Returning to the knee sector 31, from here a band 34 running towards the groin is designed to hold the thigh, groin and up to the abdominal muscles, providing support, compression, and stability, with a configuration that runs around the thigh, protecting both the quadriceps and the adductor muscles, which are normally more susceptible to traumas.

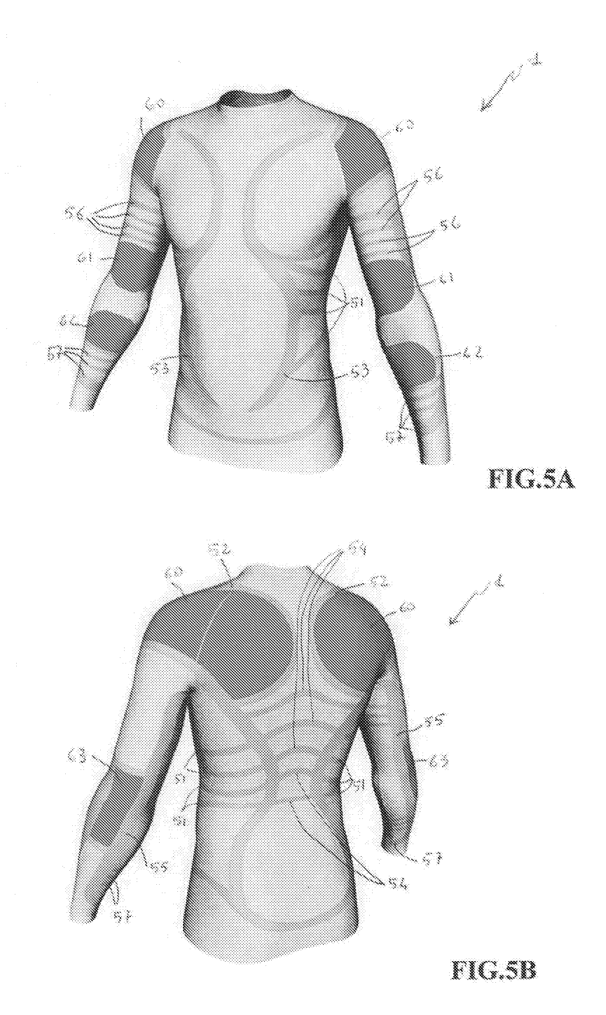

A further garment which is produced according to the present invention is a top, as shown in FIGS. 5A and 5B, which features elasticised sectors 5, which are arranged in such a configuration as to contain and support the various muscle masses, fully respecting the biomechanical function thereof.

A first sector features a series of bands 51 which are located on the side and run around the kidneys, then up towards the shoulder blades, and provide support for the oblique chest muscles, acting in synergy with an abdominal band 53 in order to provide stability for the abdominal portion and support for the spine.

In addition, the bands 52 around the shoulder and the shoulder blade promote perfect scapulohumeral rhythm.

Furthermore, a series of bands 54 are located in correspondence with the spine and are designed to provide support therefor and ensure symmetry of the muscular action between the two halves of the body,

The top envisages a further elasticised sector located on the arms wherein a longitudinal band 55 runs along the rear of the humero-ulnar axis from which perpendicular inserts 56 branch off, located in correspondence with the humeral biceps, as do further perpendicular inserts 57 located on the forearm muscles.

The said bands have the task of helping to balance the action of agonist and antagonist muscles of the front and rear socket of the entire upper limb. More specifically, the bands 56 and 57 make it possible to reduce muscle fatigue during muscle contraction.

One variant envisages the presence of a band which covers the shoulder, the shoulder blade, and the pectoral muscle.

Furthermore, the top envisages elasticised zones 60, 61, 62, and 63 having a particular weave with less compression than the elasticised sectors.

Everything illustrated so far consist of embodiments, but with the same concept other configurations of bands and elasticised areas can be created, also located in different positions and designed to support and protect other muscles used, for example, in other sports activities or other types of work/effort/movement.

After the predominantly structural description, the invention in question will now be outlined.

When a user intends to carry out sports activities or a worker performs a series of repetitive movements which require effort, such user must simply wear one or more of the garments according to the present invention to be helped and supported, as well as protected, during the various movements and efforts.

Thus the present invention achieves the objects set.

The garment with elastic inserts produced using circular machines in question features a predefined, contoured, elasticised sector which contains a stretch of elastomeric yarn in an oblique direction, as well as horizontally, or with configurations of any shape and size, to create zones able to provide support and/or pinpointed compression.

Advantageously, the garment according to the present invention adapts perfectly to the body's morphology without an uncomfortable thickness and features precise stretches of greater compression with respect to the knitting present on the same row.

Furthermore, the garment with elastic allows user to obtain stimulation of the blood circulation, a massaging effect, optimal support, and also remarkable comfort when worn.

In addition, the garment with elastic inserts can have elastic bands or elastic zones with different specific degrees of elasticity for containment inside the same sector, both vertically and horizontally or with a variable configuration.

A further advantage offered by the garment in question is that such garment can be donned and removed quickly and easily.

Advantageously, the garment according to the present invention enables a considerable reduction of the mechanical stress to the user's skin, bones, muscles and tendons, in addition to preventing contusions of both the muscles and the tendons.

In addition, the garment is donned and removed easily and quickly, offering comfort and protection without being particularly constrictive (as used to occur, for example, with the socks according to the previously known technique, in which the elastic yarn was present throughout the weave, proving particularly constrictive) and preventing unsightly bulky bulges (as occurs with the towelling inserts present in the socks according to the commonly known technique).

The garment in question allows an innovative effect to be achieved since an elastic yarn can be worked into the predetermined portions in such a way that the fabric obtained is correctly gauged, with a suitable setting which allows the desired grip to be achieved. In fact, it is not possible to produce the same fabric (as that produced following changes to the circular machine processing) by simply inserting an elastic yarn.

One advantage achieved with the present garment is that the user's performance improves since the disturbing, uncomfortable elements are reduced, making the user much safer during the movements and efforts thereof.

In particular, by reducing the stress factors, the condition after the sports activity is also improved, helping users recover their physical fitness more quickly.

One of the advantages offered by such garment is undoubtedly that of being wearable with any clothing, therefore a new way of dressing may arise herefrom as the constituent knitted fabric is flat and thin so such garment is not noticeable underneath one's clothes.

A further advantage is due to the fact that the garment in question is easy to manufacture and works well.

Naturally, further modifications or variants may be applied to the present invention while remaining within the scope of the invention that characterises it.

1-12. (canceled)

13. A garment with elastic inserts produced using circular machines, wherein the fact that such garment has elasticised sectors obtained by working in a further elastomeric yarn—in addition to the ground yarn and the reinforcing yarn normally used—and actually knitting the yarns and creating machined portions, both horizontally and obliquely, which result in well-defined and demarcated zones which provide greater compression than the knitted stitches on the same row, thereby providing—within the elasticised sectors—a greater compression value than outside the sector on the same row of knitted stitches, such elasticised sectors thereby becoming either decorative portions which create ornamental patterns or specific compression bandages which can act as support, contribute to the stimulation of blood circulation, reduce the sensation of fatigue, and make movement safer and better supported when appropriately positioned and sized.

14. A garment with elastic inserts produced using circular machines according to claim 13, wherein the fact that such garment has elasticised zones having a particular weave designed to support and massage the muscle in contact therewith.

15. A garment with elastic inserts produced using circular machines according to claim 13, wherein the fact that the presence of such elasticised sectors and such elasticised zones allows the garments to have sections of knitted fabric with different degrees of elasticity and specific degrees of containment, which provide support and create lines/portions of tension designed to perform a lymphatic massage action which stimulates the muscles, thereby providing benefits with regard to muscle or tendon fatigue.

16. A garment with elastic inserts produced using circular machines according to claim 13, wherein the fact that such garment is a sock which features one or more elasticised sectors which are located as follows:
a first sector around the ankle bone and over the neck of the foot or stretching up to the calf with a shape reminiscent of a Y, which is used to stabilise the ankle bone joint, contributing to the stimulation of the calf, and when the muscle is under tension, such sector provides support which reduces the sensation of fatigue, in addition to reducing strain,
a second elasticised sector (3) located over the neck of the foot with an extension towards the ankle on one side and towards the forefoot on the other, which wraps around the foot and is designed to contain the joint of the neck of the foot, thereby controlling the type of movement possible,
a third sector 3, placed under the foot, at the arch thereof, and running up to the inner ankle with an essentially “bean-like” shape, which is designed to support the arch of the foot, thereby providing a feeling of comfort and containment of the foot, in order to stimulate blood circulation while also providing support.

17. A garment with elastic inserts produced using circular machines according to claim 16, wherein the fact that such elasticised sectors provide external protection for parts of the foot and/or leg against blows caused by falling or by rubbing, thereby providing a cushioning effect, such protection being particularly recommended in sports socks, to protect the ankle bone or joints or muscles, and also in work hosiery for people who spend a great deal of time moving around.

18. A garment with elastic inserts produced using circular machines according to claim 13, wherein the fact that such garment is a pair of leggings which feature one or more elasticised sectors wherein:
a first sector, which surrounds the kneecap, is designed to give the user a sense of firmness, stability, and protection for the knee, alleviating strain on the ligaments and containing the muscles;
bands branching off from the first sector which run around the leg in order to support the calf;
a band, which runs from the first sector up towards the groin, which is designed to hold the thigh and groin, up to the abdominal muscles, providing support, compression, and stability, with a configuration that—running around the thigh—protects both the quadriceps and the adductor muscles,
a rear sector composed of a multitude of appropriately distributed bands, whose task is to support the gluteus, performing a lymphatic massaging actions, such multitude of bands—by stimulating microcirculation—promotes not only circulation of the lymphatic system, but also faster metabolic exchange, thereby reducing fatigue and the production of lactic acid and improving both sporting performance and endurance.

19. A garment with elastic inserts produced using circular machines according to claim 13, wherein the fact that such pair of leggings features:
in the inner portion of the first sector: a zone endowed with less elastic compression, which is designed to help support the kneecap and distribute the compression over the kneecap tendon,
an elasticised zone, located at the biceps femoris muscle of the thigh, which is endowed with a particular weave designed to support and massage such muscle;
a third zone, which is endowed with less elastic compression and designed to exert action on the twin muscle of the calf, thereby providing support and performing a massage action.

20. A garment with elastic inserts produced using circular machines according to claim 13, wherein the fact that such garment is a top which features one or more elasticised sectors which are arranged in such a configuration as to contain and support the various muscle masses, fully respecting the biomechanical function thereof, wherein:
a first sector features a series of bands which are located on the side and run around the kidneys and up towards the shoulder blades in order to provide support for the oblique chest muscles, acting in synergy with an abdominal band in order to provide stability for the abdominal portion and support for the spine.
a second area features a series of bands running around the shoulder and the shoulder blade, promoting scapulohumeral rhythm,
a third sector comprises a series of bands, which are located in correspondence with the spine and are designed to provide support therefor and ensure symmetry of the muscular action between the two halves of the body,
a fourth elasticised sector located on the arms wherein a longitudinal band runs along the rear of the humero-ulnar axis from which perpendicular inserts branch off, located in correspondence with the humeral biceps, as do further perpendicular inserts located on the forearm muscles, the said bands having the task of helping to balance the action of agonist and antagonist muscles of the front and rear socket of the entire upper limb.

21. A garment with elastic inserts produced using circular machines according to claim 20, wherein the fact that such top: features elasticised zones having a particular weave with less compression than the elasticised sectors and designed to support and protect muscular areas.

22. A process for the production of elasticised sectors according to claim 13, wherein the fact that such elasticised sectors present in the garment are obtained by inserting an elasticised yarn during the formation of the knitting, or by inserting the yarn when one intends to start creating the elasticised sector and working the elastic yarn in with the ground yarn, starting the knitting of the elastic yarn by forming a row of knitting at a given point of one round and knitting a given number of stitches, depending on the desired width; the elastic yarn is then cut and secured by knitting such yarn in with other binding yarns, which are used separately from the ground yarn to secure the stitches and are present at both the beginning of the machining with the elastomeric yarn and the end of the line in the sector, such process envisaging that the elastic yarn be brought back to the starting point of the sector by a yarn guide so as to be ready for subsequent use in the following round of knitting and on the following round, at the given point, the elastic yarn is picked up again and then machined by the number of stitches envisaged on the pattern, which can be the same number of stitches as for the previous round or more or fewer, depending on the desired shape of the sector, and the user proceeds with the processing for as many rounds as are needed to obtain the desired height and shape of the sector to be produced.

23. A process for the production of elasticised sectors according to claim 22, wherein the fact that during machining, the elastic yarn is machined together with the binding threads for a given number of stitches, at both the beginning of the sector and the end, on each row; such binding threads being designed to bind and secure the elastic yarn, knitting it in for a given number of stitches which varies depending on the desired design to be produced.

24. A process for the production of elasticised sectors according to claim 22, wherein the fact that during the knitting and the binding of the elastic yarn with another yarn used in the machining, a contour/profile can be created which “frames” the elasticised sector (3), which is highlighted if one produces a decorative design inside the sector or is less apparent if the sector is produced using a yarn with same colour.
